(19) United States
(12) Patent Application Publication
(10) Pub. No.: US 2020/0090386 A1
(43) Pub. Date: Mar. 19, 2020

(54) INTERACTIVE RELATIONSHIP VISUALIZATION CONTROL INTERFACE

(71) Applicant: International Business Machines Corporation, Armonk, NY (US)

(72) Inventor: Shay Hall, Durham, NC (US)

(21) Appl. No.: 16/135,613

(22) Filed: Sep. 19, 2018

(51) Int. Cl. G06T 11/20; G06Q 10/06; G06F 3/0481; G06F 3/0484

(52) U.S. Cl. CPC G06T 11/206; G06F 3/04842; G06F 3/04812; G06Q 10/06

(57) ABSTRACT

Methods, computer program products, and systems are presented. The method computer program products, and systems can include, for instance: rendering on a display screen a folded multidimensional relationship diagram, wherein the folded multidimensional relationship diagram includes first, second, and third stacks of active bars associated respectively to first, second and third condition parameters, wherein respective bars of first stack of active bars are associated to respective condition parameter values of the first condition parameter, wherein respective bars of second stack of active bars are associated to respective condition parameter values of the second condition parameter, wherein respective bars of third stack of active bars are associated to respective condition parameter values of the third condition parameter; and providing one or more output in dependence on one or more input received from the user.

### BACKGROUND

Many information handling systems include a graphical user interface (GUI) with which a user communicates with the system. A GUI includes the use of graphic symbols or pictures, rather than just words, to represent objects or elements in the system. Program code is associated with a graphic symbol in order to allow the graphic symbol to possess certain desired behaviors. A graphic symbol, along with its associated program code, make up a GUI control element.

Programs which include a GUI typically render on a display screen many graphics including graphical symbols, which can be utilized by a user to communicate with the program and/or control events in the system. For example, a program may require user input regarding two possible choices. To obtain the necessary user input, the program may render a selection graphical symbol on the screen. The user can make an appropriate selection by touching in the case of a touch sensitive GUI, and/or with use of a pointer controller.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g. in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience.

### SUMMARY

Shortcomings of the prior art are overcome, and additional advantages are provided, through the provision, in one aspect, of a method. The method can include, for example: rendering on a display screen a folded multidimensional relationship diagram, wherein the folded multidimensional relationship diagram includes first, second, and third stacks of active bars associated respectively to first, second and third condition parameters, wherein respective bars of first stack of active bars are associated to respective condition parameter values of the first condition parameter, wherein respective bars of second stack of active bars are associated to respective condition parameter values of the second condition parameter, wherein respective bars of third stack of active bars are associated to respective condition parameter values of the third condition parameter, wherein the folded multidimensional relationship diagram includes a first segment set that connects bars of the first stack of active bars to bars of the second stack of active bars, a second segment set that connects bars of the second stack of active bars to bars of the third stack of active bars, and a third segment set that connects bars of the third stack of active bars to bars of the first stack of active bars; receiving one or more input from a user, the one or more input being in dependence on a user's interaction with the folded multidimensional relationship diagram rendered on the display screen; and providing one or more output in dependence on the one or more input received from the user.

In another aspect, a computer program product can be provided. The computer program product can include a computer readable storage medium readable by one or more processing circuit and storing instructions for execution by one or more processor for performing a method. The method can include, for example: rendering on a display screen a folded multidimensional relationship diagram, wherein the folded multidimensional relationship diagram includes first, second, and third stacks of active bars associated respectively to first, second and third condition parameters, wherein respective bars of first stack of active bars are associated to respective condition parameter values of the first condition parameter, wherein respective bars of second stack of active bars are associated to respective condition parameter values of the second condition parameter, wherein respective bars of third stack of active bars are associated to respective condition parameter values of the third condition parameter, wherein the folded multidimensional relationship diagram includes a first segment set that connects bars of the first stack of active bars to bars of the second stack of active bars, a second segment set that connects bars of the second stack of active bars to bars of the third stack of active bars, and a third segment set that connects bars of the third stack of active bars to bars of the first stack of active bars; receiving one or more input from a user, the one or more input being in dependence on a user's interaction with the folded multidimensional relationship diagram rendered on the display screen; and providing one or more output in dependence on the one or more input received from the user.

In a further aspect, a system can be provided. The system can include, for example a memory. In addition, the system can include one or more processor in communication with the memory. Further, the system can include program instructions executable by the one or more processor via the memory to perform a method. The method can include, for example: rendering on a display screen a folded multidimensional relationship diagram, wherein the folded multidimensional relationship diagram includes first, second, and third stacks of active bars associated respectively to first, second and third condition parameters, wherein respective bars of first stack of active bars are associated to respective condition parameter values of the first condition parameter, wherein respective bars of second stack of active bars are associated to respective condition parameter values of the second condition parameter, wherein respective bars of third stack of active bars are associated to respective condition parameter values of the third condition parameter, wherein the folded multidimensional relationship diagram includes a first segment set that connects bars of the first stack of active bars to bars of the second stack of active bars, a second segment set that connects bars of the second stack of active bars to bars of the third stack of active bars, and a third segment set that connects bars of the third stack of active bars to bars of the first stack of active bars; receiving one or more input from a user, the one or more input being in dependence on a user's interaction with the folded multidimensional relationship diagram rendered on the display screen; and providing one or more output in dependence on the one or more input received from the user.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a client computer device provided by a mobile computer device having a display screen rendered user interface having a folded multidimensional relationship diagram according to one embodiment;

FIG. 2 is a block diagram illustrating a system having a manager system, a services system, and a client computer device according to one embodiment;

FIG. 3 is a flowchart illustrating a method that can be performed by a manager system according to one embodiment;

FIG. 4 depicts a display screen rendered user interface for configuration of a user interactive display screen rendered user interface according to one embodiment;

FIG. 5 depicts a display screen rendered user interface having a rectangular multidimensional relationship diagram according to one embodiment;

FIG. 6 depicts a rendered user interface having a grid including multidimensional relationship diagram supporting data according to one embodiment;

FIG. 7 depicts a client computer device provided by a mobile computer device having a display screen rendered user interface having a folded multidimensional relationship diagram according to one embodiment;

FIGS. 8-11 depict display screen rendered user interfaces that include multidimensional relationship diagrams with various differentiated user interface functionalities according to respective embodiments;

FIG. 12 depicts a computing node according to one embodiment;

FIG. 13 depicts a cloud computing environment according to one embodiment; and

FIG. 14 depicts abstraction model layers according to one embodiment.

### DETAILED DESCRIPTION

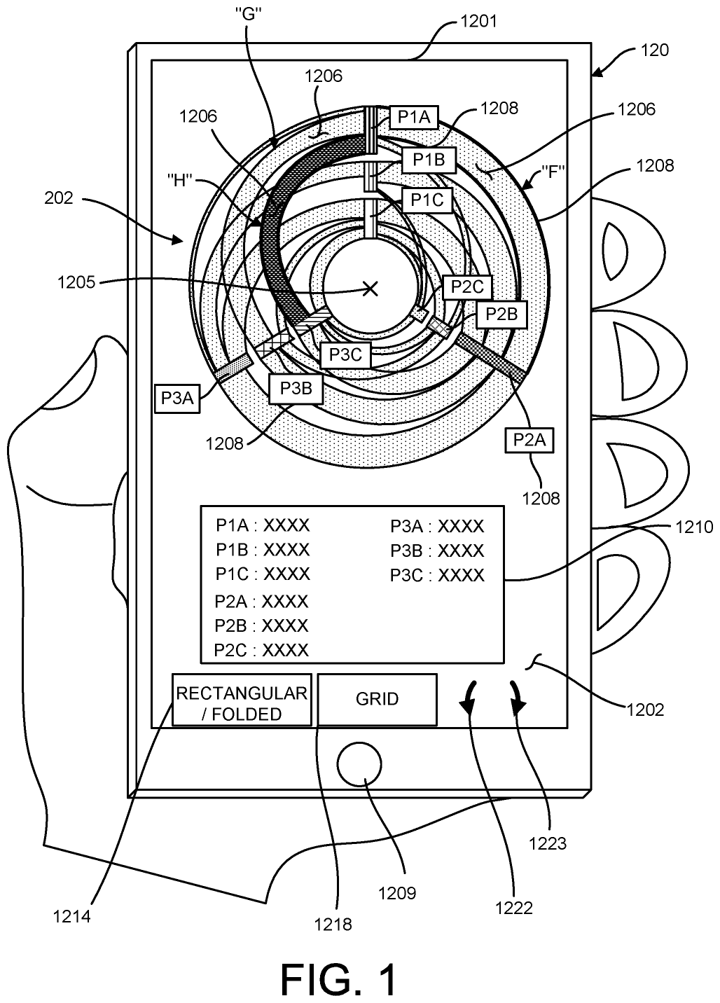

Client computer device 120 having user interface functionality is shown in FIG. 1. Client computer device 120 can include a display screen 1202 on which there can be rendered a user interface having an interactive folded multidimensional relationship diagram that can be interacted with to facilitate artificial intelligence (AI) data decisions and/or the providing of outputs for presentment to control interfaces to control visualizations and/or other processes.

Folded multidimensional relationship diagram 202 depicts relationships among data in multiple dimensions such as in datasets in which members are characterized by multiple different condition parameters. The different condition parameters according to one example can be information technology (IT) related condition parameters.

According to one example, condition parameters can include, e.g. a central processing unit (CPU) utilization condition parameter, a graphical processing unit (GPU) utilization condition parameter, and a memory utilization condition parameter. The values associated with a CPU utilization parameter can include e.g. (a) high, (b) medium, and (h) low. The values associated with memory utilization parameter can include e.g. (a) high, (b) medium, and (h) low. The values associated with a GPU utilization parameter can include e.g. (a) high, (b) medium, and (h) low.

According to one example, condition parameters can include, e.g. a computing node storage condition parameter, a computing node deployment condition parameter, and computing node utilization condition parameter. The different condition node parameters can have different condition node parameter values. Computing node storage condition parameter values can include, e.g. the parameter values of (a) available, (b) used, or (c) failed. Computing node deployment parameter values can include the parameter values, e.g. of (a) healthy, (b) unhealthy, and (c) inactive. Computing node utilization parameter values can include the parameter values, e.g. of (a) low, (b) medium, and (c) high. Computing node utilization levels can be determined in dependence, e.g. based on one or more of central processing unit (CPU) utilization, memory utilization, and/or graphical processing unit (GPU) utilization.

In cases where condition parameter values are expressed in terms of high, medium, or low, or low, medium, and high, it will be understood that fewer (e.g. just low and high) or a greater number (e.g. on a number scale from 1 to N) of magnitude levels can be defined. The different magnitude levels e.g. high, medium, low can be based on e.g. certainly defined ranges of utilization using the condition parameter value measurement units provided by an IT management system. Defined ranges according to one embodiment can be defined by an administrator user using an administrator user interface.

Referring to FIG. 1, user interface 1201 has features to facilitate AI decisions in environments having dataset members that can be characterized by multiple condition parameters. The members can include e.g. computer system resources such as computing nodes, or other types of members such as human individuals in the case of healthcare AI analytics applications.

Embodiments herein recognize that in many technical environments in which conditions data is available, obtained data can be so voluminous that high quality machine decisions, human-aided machine decisions, and machine-aided human decisions are not possible or practical based on the data, particularly where data decisions are required expeditiously, where there is restricted opportunity for human input of data. One example is in the environment of an IT management system, which can monitor conditions within a computer system, e.g. related to storage, health, and/or utilization, e.g. CPU utilization, memory utilization, and/or GPU utilization. IT management systems can present complex dashboards, including graphical depictions, e.g. barometers, dials, gauges, etc. rendering values of multiple measured condition parameters. Embodiments herein recognize that administrators can become overwhelmed viewing such user interface presentments, particularly when addressing computer system emergencies. Embodiments herein recognize that use of systems rendering multiple depictions, e.g. barometers, dials, gauges, etc. often lead to inaccurate and/or delayed and untimely decisions being made. An administrator must engage in intensive mental practices, often aided by manual notes to glean relationships between different condition parameters.

Embodiments herein recognize that in emergency conditions administrator users can be in the field using a mobile client computer device e.g. a smartphone having a small display screen with reduced space for data entry or visualization. Embodiments herein recognize that in emergency conditions administrator user are more likely to be relying on multiple user interface equipped client computer devices, with one or more of the multiple computer devices being provided by a mobile client computer device e.g. smartphone having a small screen.

Embodiments herein feature advanced user interface functionality to facilitate improved machine outputs for presentment to a visualization control interface and/or one or more process control interface for controlling one or more process other than a visualization processes, and to facilitate improved AI decisions such as improved human-aided machine decisions, improved machine-aided human decisions. Embodiments herein feature advanced user interface functionality to facilitate improved human interactions with a computer system for more accurate and efficient data related decisions. Various embodiments include features in the environment of computer systems having small display screens such as handheld mobile smartphones having display screens of reduced size.

Referring to client computer device 120 as shown in FIG. 1, client computer device 120 can render on display screen 1202 rendered user interface 1201. Rendered user interface 1201 can render folded multidimensional relationship diagram. Folded multidimensional relationship diagram 202 can include various active control buttons, such as control buttons P1A, P1B, P1C, P2A, P2B, P2C, P3A, P3B, and P3C (hereinafter P1A-P3C). Buttons P1A-P3C can be active bars and each active bar can be associated to a condition parameter. Each bar P1A-P3C can be an active bar operative so that interaction with a bar or a set of bars alters features of a user interface 1201 rendered for display on a display screen 1202. For example, pressing and holding a first one or more bar can produce a first result, double pressing one or more bar can produce a second result, and so on. Interactions can trigger visualizations to reveal data attributes including relationships between condition parameters and can be useful in the return of data decisions and outputs for presentment to a visualization control interface as referenced and/or to one or more process control interface to control a process other than a visualization process.

There is set forth herein rendering on a display screen a folded multidimensional relationship diagram 202, wherein the folded multidimensional relationship diagram includes first, second, and third stacks of active bars (P1A-P3A, P1B-P3B, P1C-P3C) associated respectively to first, second and third condition parameters, wherein bars of the active bars are associated to condition parameter values of the first second, and third conditions parameters, wherein the folded multidimensional relationship diagram 202 includes a first segment set that connects bars of the first set of bars to bars of the second set of bars, a second segment set that connects bars of the second set of bars to bars of the third set of bars, and a third segment set (e.g. including the segment 1206 at “G” and the segment the segment “H”) that connects bars of the third set of bars to bars of the first set of bars. Folded multidimensional relationship diagram 202 can be regarded to be a Sankey diagram.

According to one embodiment, bars P1A, P1B, and P1C can be associated to a first condition parameter of a first category, e.g. the first condition parameter being a CPU utilization parameter including various values of P1A: (a) high, P1B: (b) medium, and P1C: (c) low.

Further, bars P2A, P2B, and P2C can be associated to a second condition parameter of a second category, the second condition parameter being a GPU usage condition parameter having various values e.g. P2A: (a) high, P1B: (b) medium, and P1C: (c) low.

Further, bars P3A, P3B, and P3C can be associated to a condition parameter of a third category, e.g. a memory usage condition parameter having such values as P3A: (a) high, P1B: (b) medium, and P1C: (c) low.

In one example according to user interface 1201 depicted in FIG. 1, the described example bars P1A-P3C can be associated to condition parameter values of computing nodes within computing nodes of a services system.

Bar length can have a significance e.g. can indicate a quantity (e.g. count quantity or percentage quantify having the condition parameter value associated to the bar. For example, in the described example a relatively long length of bar P2A and relatively short length of bar P2C can indicate that there are relatively large number of computing nodes in a services system having high GPU utilization and a relatively low number of nodes in a services system having low GPU utilization. The length of the bars can be proportional to a number of units. For example, small length bar representing ten computing nodes having low GPU usage can include a length of ten units, whereas a second bar representing fifty computing nodes having high CPU usage can include a length of fifty units. For visualization so that relationships can be easily observed, the bars for each represented condition parameter (e.g. the bars P1A, P1B, B1C) can be arranged in a straight line with each bar for a given condition parameter having minimal space therebetween (e.g. spaces between bars can consume less than about 20 percent of a length of a set of bars for a given condition parameter). The geometrical relationships between bars can be as be depicted in the drawings.

Folded multidimensional relationship diagram 202 can include segments 1206 such as curved segments connecting bars of bars P1A-P3C. Segments 1206 depict relationships between condition parameters associated to different bars P1A-P3C. According to one embodiment, each bar of bars P1A-P3C can be connected to one or more bar of a first bar set outside of its condition parameter category and can be connected to one or more bar of a second bar set outside of its condition parameter category.

For example, bar P1A can include a segment connected to one or more bar of bars P2A-P2C and one or more bar of bars P3A-P3C. The width of each segment 1206 can have significance, e.g. can indicate a quantity (e.g. count or percentage) of members (e.g. computer system resources, individuals) having the condition parameter value associated to a first bar and a condition parameter value associated to a second bar.

For example, with reference to FIG. 1 and in accordance with one dataset example, segment 1206 at “F” connects bar P1A associated to the condition parameter value of high CPU utilization, and bar P2A associated with the condition parameter value of high GPU utilization. That means, that the quantity of members (in this case computing nodes) that exhibit both of the conditions of high CPU utilization and high GPU utilization can be indicated by a width of segment 1206 at location “F”. A first segment 1206 indicating a quantity of ten computing nodes can have ten times the width of an alternative segment 1206 indicating that there is only one computing node that has both high CPU utilization and high GPU utilization.

With further reference to folded multidimensional relationship diagram 202 of user interface 1201 rendered on display screen 1202, segment 1206 at “G” connects bar P1A associated to the parameter condition value CPU utilization high to bar P3B associated to the condition parameter value medium utilization. In the example described, segment 1206 at location “G” indicates a quantity (e.g. count) of computing nodes exhibiting the conditions of having both high CPU utilization and medium memory utilization.

User interface 1201 can be configured so that user interface 1201 is responsive to user interactions with bars and/or segments of folded multidimensional relationship diagram 202. For example, with reference to FIG. 1, the first input characterized by a first finger, e.g. thumb pressing on bar P3C and a second finger pressing on bar P1A simultaneously with the pressing of bar P3C can result in segment 1206 at location “H” being highlighted, as indicated in FIG. 1. The highlighting can include, e.g. presenting in a different color, pattern, brightness, density, thickness and/or sharpness, relative to remaining un-highlighted segments 1206. The described functionality can expedite data decisions that are made using user interface 1201.

Referring to additional features of user interface 1201, rendered on display screen 1202, user interface 1201 can include area 1210 that can render a key. Each bar P1A-P3C can include a label 1208 as indicated in FIG. 1, in which a bar identifier can be rendered as shown in FIG. 1. The label associated to each bar can render an identifier for a bar, e.g. can be the text specifying the bar reference elements P1A-P3C described herein. In area 1210 there can be included rendered text specifying the condition parameter value associated to each bar identifier.

For example, area 1210 can include text specifying e.g. that bar P1A is a condition parameter value specifying high CPU utilization, bar P1B is a condition parameter value specifying medium CPU utilization, and bar P1C is a condition parameter specifying low CPU utilization, as well as text explaining the condition parameter associated to each of the remaining bars P2A-P3C.

Active control 1214 of user interface 1201 allows toggling to a rectangular multidimensional relationship diagram characteristics of which will be set forth herein. Labels 1208 associated to bars P1A-P3C can include polygonal or alternatively shaped graphical features as shown in FIG. 1 having embedded therein text based identifiers for the bars, e.g. the identifiers P1A-P3C. In another embodiment the labels can be embedded on the bars P1A-P2C themselves. In another embodiment, the identifiers can include text mnemonics that specify the condition parameter value associated to the bars, e.g. one bar can be labeled “CPU utilization high” and another bar of the same condition parameter can be labeled “CPU utilization medium”.

Controls 1222 and 1223 permit clockwise or counter clockwise rotation of folded multidimensional relationship diagram 202. Embodiments are particularly useful for implementation on display screens of mobile client computer devices, e.g. smartphones where there is reduced area for rendering of graphical or text based data. Applications are facilitated where an IT administrator can quickly resolve services system problems using a mobile client computer device having a display screen of a reduced size.

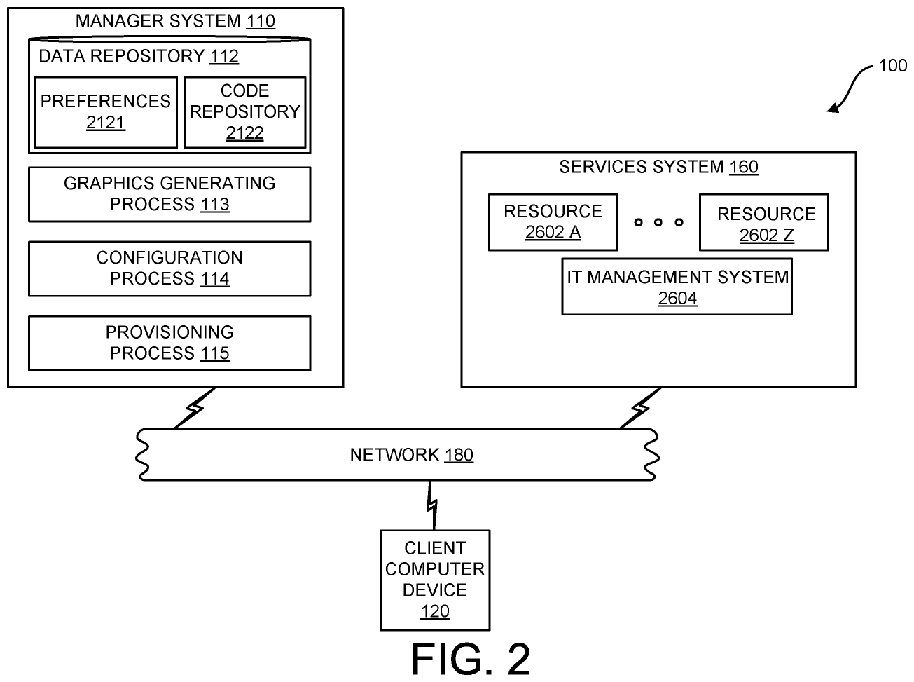

A system schematic view of system 100 having client computer device 120 is illustrated in FIG. 2. System 100 can include manager system 110 having an associated data repository, services system 160, and client computer device 120. Manager system 110, services system 160, and client computer device 120 can be in communication with one another via network 180. System 100 can include numerous devices which may be computing node based devices connected via network 180. Network 180 can be a physical network and/or a virtual network. The physical network can be for example a physical telecommunications network connecting numerous computing nodes or systems such as computer servers and computer clients. The virtual network can for example combine numerous physical networks or parts thereof into a logical virtual network. In another example, numerous virtual networks can be defined over a single physical network.

In one embodiment, manager system 110 can be external to services system 160 and client computer device 120. In another embodiment one or more of manager system 110, services system 160, and/or client computer device 120 can be collocated with one another. In one embodiment, services system 160 can include resources 2602A-2602Z.

Resources of resources 2602A-2602Z can include e.g. applications and/or computing nodes running such applications. Applications running on computing nodes can configure such computing nodes as servers, such as, e.g., web servers, mail servers, database servers, real-time communication servers, artificial intelligence (AI) servers, FTP servers, and/or collaboration servers. One or more IT management system 2604 of services system 160 can run on resources of resources 2602A-2602Z. One or more IT management system 2604 can include, in one embodiment, IT management systems of different types. According to one embodiment resources of resources 2602A-2602Z can include computing nodes, e.g. physical computing nodes or virtual computing nodes provided by hypervisor based virtual machines (VMs) running on one or more physical computing node.

One or more IT management system 2604, in one embodiment, can be provided by an application performance management (APM) system. An APM system can monitor and manage performance and availability of software applications. An APM can detect and diagnose complex application performance problems to maintain an expected level of service. One example of an application performance metric that can be tracked using an APM IT management system is an application response time under peak load. APM can also measure resources used by an application for a load, e.g., indicating whether there is adequate capacity to support the load, as well as possible locations of performance bottlenecks. Response times for components of applications can be monitored to help identify causes of a delay. An APM can provide user experience monitoring, e.g., user experience monitoring, application runtime monitoring, and user-defined transaction profiling.

In one embodiment, IT management system 2604 can include an IT management system that monitors system-level functionalities, such as CPU usage and frequency, the amount of free RAM space, the amount of space on one or more hard drives, CPU temperature, IP address utilization (such as current rates of uploads and downloads), system uptime and downtime, hard drive parameter data, and voltages being provided by a power supply. One commercially available for use in providing an IT management system is IBM® Tivoli IT Management System, available from International Business Machines Corporation, of Armonk, N.Y., USA (IBM® and Tivoli® are registered trademarks of International Business Machines Corporation).

In one embodiment, IT management system 2604 can include an event monitoring IT management system. Events that can be monitored can include, for example, overloading events, out-of-memory events, VM migration events. An example of a commercially available event IT management system for managing events is IBM® OMNIbus®, available from International Business Machines Corporation (IBM® and OMNIbus® are registered trademarks of International Business Machines Corporation).

In one embodiment, IT management system 2604 can include an event logging IT management system. An event logging IT management system can perform logging of events from e.g. applications, network devices, operating systems, and containers. An example of a commercially available event logging IT management system is the open source GRAYLOG™ event logging IT management system available from Graylog, Inc. (GRAYLOG is a trademark of Graylog, Inc.).

In one embodiment, services system 160 can include services application software that facilitates the installation and maintenance of resources 2602A-2602Z, and which incorporates features of one or more IT management system 2604. One example of such service support software is IBM® Cloud Prime® (IBM® and Cloud Prime® are registered trademarks of International Business Machines Corporation).

Manager system 110 can run various processes. Manager system 110 can run for example, graphics generating process 113 for generating, e.g. multidimensional relationship diagrams and other user interface features examples of which are explained. Graphics generating process 113 can control the rendering of graphics in dependence on received user inputs. User inputs can be received for example, to change formats of multidimensional relationship diagrams, e.g. from rectangular to folded multidimensional relationship diagrams and vice versa. Received inputs can include, e.g. inputs provided by user interaction with bars P1A-P3C and/or segments 1206 which connect bars. For example, in response to a received input that is input using one or more bar of bars P1A-P3C, a related segment 1206 between first and second bars can be highlighted so that it stands out in appearance in relation to other segments 1206 of a multidimensional relationship diagram.

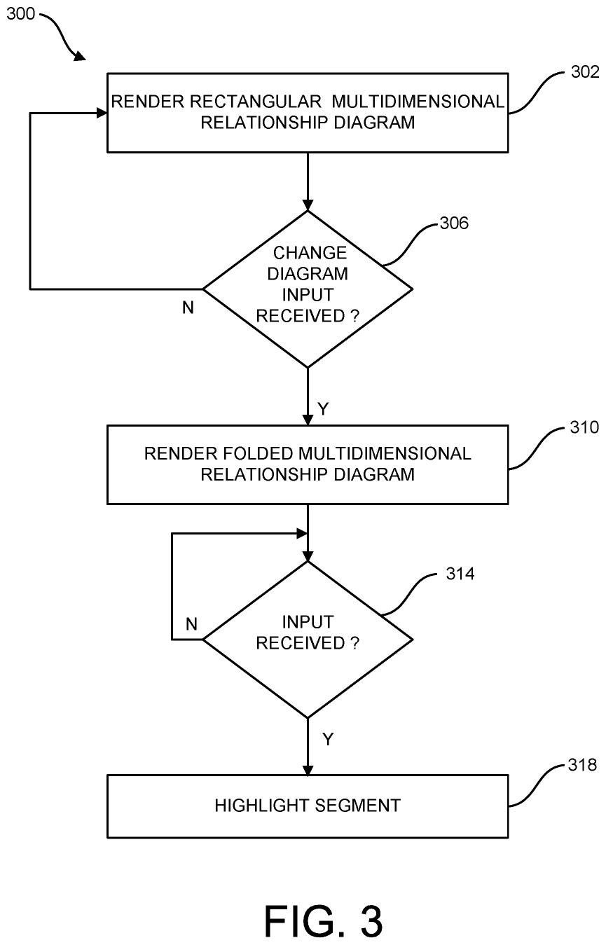

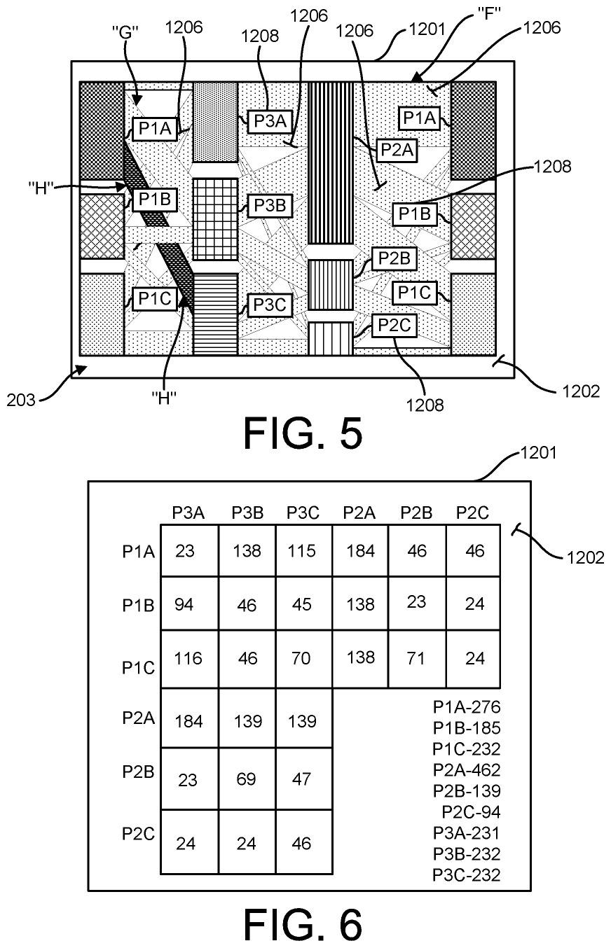

A method 300 that can be run by manager system 110 by the running of graphics generating process 113 (FIG. 1) is set forth in reference to FIG. 3. At block 302, manager system 110 can render on a display screen 1202 of client computer device 120, a rectangular multidimensional relationship diagram 203. The rectangular multidimensional relationship diagram 203 rendered at block 302 can include according to one embodiment three sets of bars, as in the folded multidimensional relationship diagram 202 described in reference to FIG. 1. However, in order to render bars in a manner to depict relationships between condition parameters associated with the various sets of bars, one of the sets of bars e.g. (bars P1A-P1C) is rendered redundantly, e.g. as a first set of bars and duplicated as a last set of bars as shown in FIG. 5. Rectangular unfolded multidimensional relationship diagram 203 can be regarded to be a Sankey diagram.

With further reference to the flowchart of FIG. 3, manager system 110 at block 306 can monitor for receipt of a user input commanding the change of a rendered multidimensional relationship diagram. For example, with reference to FIG. 1 a user input to change a multidimensional relationship diagram can be implemented by pressing button 1214 which allows a user to toggle between a rectangular multidimensional relationship diagram and a folded multidimensional relationship diagram. On receipt of a changed diagram input at block 306, manager system 110 at block 310 can render a folded multidimensional relationship diagram 202, e.g. as shown in FIG. 1. Folded multidimensional relationship diagram 202 (FIG. 1) can be folded so that that first, second, and third sets of bars can be rendered in a manner that a first set of segments connects bars of the first set of bars with bars of a second set of bars, the second set of segments connects bars of the second set of bars to bars of a third set of bars, and bars of a third set of segments connects bars of the third set of bars to the first set of bars. The format avoids the repeating of a set of bars as in a rectangular multidimensional relationship diagram 203 shown in FIG. 5.

At block 314 manager system 110 can monitor for receipt of a highlight user input. The highlight user input according to one example can be as described in reference to FIG. 1, wherein a user interacts, e.g. with use of finger forces with one or more bar in a specified manner. On receipt of a highlight input at block 314 manager system 110 proceeds to block 318 to activate a highlight. An activated highlight can be as described in FIG. 1, wherein the segment 1206 connecting bar P3B and bar P1A at location “H” is highlighted to stand out visually from remaining segments.

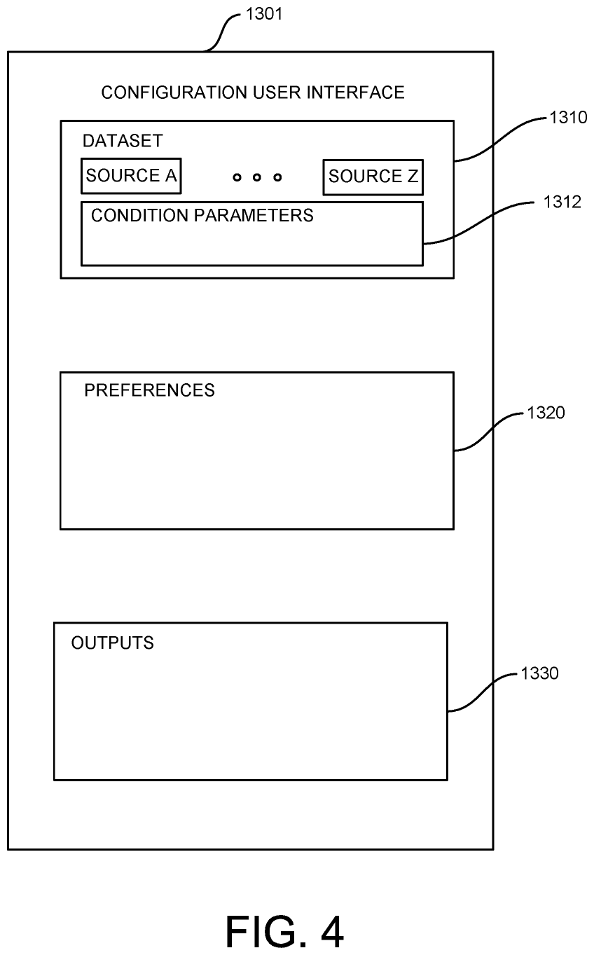

Manager system 110 running configuration process 114 can configure user interface 1201 (FIG. 1) so that user interface 1201 renders selected data in a selected manner to facilitate and optimize AI data decisions and outputs for presentment to a visualization control interface and/or to one or more process control interface for controlling one or more non-visualization process. Configuration user interface 1301 is illustrated in FIG. 4.

Manager system 110 running provisioning process can according to one embodiment auto-provision dataset members e.g. computer system resources such as computing nodes that are identified or otherwise represented in a user interface rendered on a display screen 1202 wherein the rendered user interface includes a multidimensional relationship graph.

Configuration user interface 1301 can be rendered on a display screen 1202 of client computer device 120. Subsequent to the use of user interface 1301 with the configuration of user interface 1201, user interface 1201 can be rendered and user interfaces 1201 and 1301 can be configured to permit toggling therebetween e.g. with use of home button 1209. In area 1310 the user can make selections regarding the dataset. A user, e.g. can select from data between source A and source Z. Source A for example can be data from services system 160 being monitored using IT management system 2604. However, other data sources can be selected, e.g. medical data sources storing medical test data for individuals as well as databases storing customer test and survey data for optimizing services to customers, e.g. in any arbitrary service, e.g. healthcare service, food service, entertainment service, accounting service, legal service, and the like.

Tables A, B, C and D below illustrate various data that can be subject to data decisions using user interface 1201 by selection of differentiated data sources. Table A illustrates data of an IT environment data source, e.g. data provided by IT management system 2604 of services system 160.

TABLE A

| Category 1: | Category 2: | Category 3: Memory |
|---|---|---|
| CPU Utilization | GPU utilization | utilization |
| P1A: High | P2A: High | P3A: High |
| P1B: Medium | P2B: Medium | P3B: Medium |
| P1C: Low | P2C: Low | P3C: Low |

Condition parameter values represented by bars P1A-P1C in accordance with Table A can include condition parameter values of the condition parameter CPU utilization. The condition parameter values can include P1A: high, P1B: medium, or P1C: low. Bars P2A-P2C can be associated condition parameter values of the GPU utilization condition parameter in accordance with Table A and can include the condition parameter values P2A: high, P2B: medium, and P2C: low. Bars P3A-P3C in accordance with Table A can include condition parameter values of the condition parameter memory utilization and include the condition parameter values of P3A: high, P3B medium, and P3C: low.

Table B illustrates data of an IT environment data source, e.g. data provided by IT management system 2604 of services system 160.

TABLE B

| | | Category 3: Utilization |
|---|---|---|
| | | (e.g. of CPU, Memory, |
| Category 1: Storage | Category 2: Deployment | and/or GPU |
| P1A: Available | P2A: Healthy | P3A: Low |
| P1B: Used | P2B: Unhealthy | P3B: Medium |
| P1C: Failed | P2C: Inactive | P3C: High |

Condition parameter values represented respectively by bars P1A-P1C in accordance with Table B can include condition parameter values of the category computing node storage. The condition parameter values can include P1A: computing node storage available, P1B: computing node storage used, or P1C: computing node storage failed. Bars P2A-P2C can be associated to condition parameter values of the deployment condition parameters in accordance with Table A and can include the condition parameter values P2A: computing node healthy, P2B: computing node unhealthy, and P2C: computing node inactive. Bars P3A-P3C in accordance with Table A can be associated to condition parameter values of the condition parameter utilization in accordance with Table A and can include the condition parameter values of P3A: computing node low utilization, P3B: computing node medium utilization, and P3C: computing node high utilization. Computing node utilization can be based, e.g. on CPU utilization, memory utilization, and/or GPU utilization.

Table C summarizes dataset data from a medical environment.

TABLE C

| Category 1: Age | Category 2: Cancer Stage | Category 3: Smoker Stage |
|---|---|---|
| P1A: Under 35 | P2A: Stage 1 | P3A: Not a smoker |
| P1B: 35-60 | P2B: Stage 2-3 | P3B: Light smoker |
| P1C: Over 60 | P2C: Stage 4 | P3C: Heavy Smoker |

In accordance with Table C bars P1A-P1C can represent condition parameter values of an age condition parameter, wherein the condition parameter value P1A is the condition parameter value under 35, the condition parameter value P1B is the condition parameter value of ages 35-60, and the condition parameter value P1C is the condition parameter value of ages over 60. Bars P2A-P2C can be associated to condition parameter values of the cancer stage condition parameter category in accordance with Table C. Bars P2A can be associated to the condition parameter value “cancer stage 1”, bar P2B can be associated to the cancer stage condition parameter value cancer stages 2-3, and bars P2C can be associated to the cancer stage condition parameter value cancer stage 4. Bars P3A-P3C in accordance with Table C can be associated to condition parameter values of a smoker status condition parameter. Bar P3A can be associated to the condition parameter value of “not a smoker”, bar P3B can be associated to the condition parameter value of “light smoker”, and bar P3C can be associated to the condition parameter value of “heavy smoker.”

Now referring to Table D, Table D illustrates dataset data for use in facilitating services optimization decisions.

TABLE D

| Category 1: Meal Type | Category 2: Beverage | Category 3: Age |
|---|---|---|
| P1A: Breakfast | P2A: Water | P3A: Child (0-17) |
| P1B: Lunch | P2B: Soda | P3B: 18-64 |
| P1C: Dinner | P3C: Tea | P3C: 65+ |

Bars P1A-P1C in accordance with Table D can be associated to the condition parameter meal type. Bar P1A can indicate instances of the condition parameter value breakfast, bar P1B can indicate instances of the condition parameter value lunch, and bar P1C can indicate instances of the condition parameter value dinner. Bars P2A-P2C in accordance with Table C can be associated to the condition parameter beverage. Bar P2A can indicate instances of the condition parameter value water, bar P2B can indicate instances of the condition parameter soda, and bar P2C can indicate instances of the condition parameter value tea. Bars P3A-P3C in accordance with Table C can be associated to the condition parameter age. Bar P3A can indicate instances of the condition parameter value child (0-17), par P3B can indicate instances of the condition parameter value of the age group 18-65, and bar P3C can indicate instances of the condition parameter value of the age group of 65 and over.

Referring further to configuration user interface 1301, a user can use area 1312 to select and define condition parameters for rendering e.g. graphically and/or textually with user interface 1201. In area 1320 of user interface 1301, the user can define preferences. For example, a user can define preferences involving the format of rendered multidimensional relationship diagrams, e.g. the color or pattern of bar labeled configurations, bar shape and size, segment shape and size, and the like. Using preferences area 1320 a user can select a certain multidimensional relationship diagram as a default diagram, e.g. can select a folded multidimensional relationship diagram 202 as a default diagram or can select a rectangular multidimensional relationship diagram as a default diagram. On initial rendering of user interface 1201, the default multidimensional relationship diagram can be rendered. However, a user is able to toggle to an alternative multidimensional relationship diagram using active control 1214 allowing a user to switch, e.g. from a rectangular unfolded multidimensional relationship diagram to a folded multidimensional relationship diagram. Preferences that are defined by a user using preferences area 1320 can be stored in preferences area 2121 of data repository 112.

Using area 1330 a user can define outputs associated with rendered multidimensional relationship diagrams, e.g. can define one or output for presentment to a visualization control interface and/or one or more process control interface. For example, using area 1330 according to one embodiment, a user can configure a multidimensional relationship diagram rendering IT management data so that in response to one or more user input by a user, manager system 110 identifies associated computing nodes and provisions targeted computing nodes in accordance with the provisioning of the identified computing nodes.

Referring to FIG. 5, FIG. 5 illustrates a rectangular multidimensional relationship diagram which can be rendered as part of user interface 1201, rendered on a display screen 1202 as shown in FIG. 1, e.g. in response to activation of button 1214. Rectangular multidimensional relationship diagram 203 includes rendered data of folded multidimensional relationship diagram 202 (FIG. 1) except that the data is rendered in rectangular format with bars of first, second, and third condition parameter categories being rendered parallel to one another.

While rendering a rectangular multidimensional relationship diagram can be advantageous for various applications, embodiments herein recognize potential limitations with rendering of a rectangular unfolded multidimensional relationship diagram 203. In rectangular unfolded multidimensional relationship diagram 203 a first set of segments 1206 can act as a first set of bars associated to a first condition parameter to a second set of bars associated to a second condition parameter, a second set of segments 1206 connects a second set of bars to a third set of bars, and a third set of segments 1206 connects a third set of bars to the first set of bars. However, embodiments herein recognize that due to the format of multidimensional relationship diagram the first set of bars P1A-P1C needs to be presented redundantly, i.e. both as a first and a last set of bars.

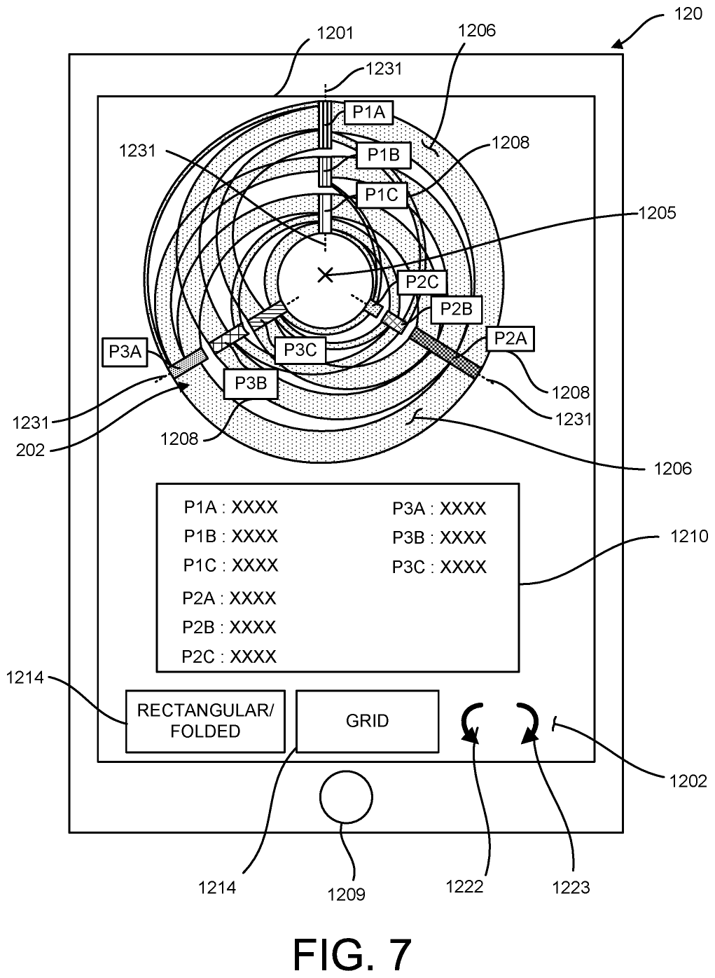

Embodiments herein recognize that the double presentment of bars P1A-P1C can engender a perception of hierarchy or temporal linear progression, which is nonapplicable to the dataset being interacted with by the user for the providing of active outputs. Embodiments herein recognize that folded multidimensional relationship diagram 202 as shown in FIG. 1 can provide improved performance relative to multidimensional relationship diagram 203 as depicted in FIG. 5, for certain applications. For example, rendered folded multidimensional relationship diagram 202 like rendered rectangular multidimensional relationship diagram 203, can include render sets of bars P1A-P1C, P2A-P2C, and P3A-P3C in a manner that each bar of a bar set e.g. P1A-P1A is rendered in a straight line with each bar being rendered in an end to end manner with longitudinal axes of the bars being aligned along common axis 1231 (as shown in FIG. 7), and with spaces between the bars. However, in folded multidimensional relationship diagram 202 sets of stacked bars each corresponding to a different condition parameter can be rendered in a nonparallel manner. For example, as shown in FIG. 1 each set of stacked bars, namely stacked bars P1A-P1C, P2A-P2C, and P3A-P3C, can be arranged as stacked straight linear bars but can each can be arranged so that each set of stacked bars is pointed to a center 1205 of folded multidimensional relationship diagram 202.

In FIG. 5 three stacked bar charts 1-2-3 are used to compare the subsets between each with the others in a rectangular unfolded multidimensional relationship diagram 203. But instead of repeating each bar chart for each comparison, they can be combined (1-2-3-1), but this still repeats A. By rotating the three stacked bar charts out in a tripod structure (FIG. 1) with the bases all pointing toward the middle and the flows between each wrapping in a circular fashion like a folding fan, the relationship between any number of subsets of each condition parameter expressed by a set of bars can be compared between all condition parameters without any visual hierarchy or repetition of columns. The elimination of a rendered bar conserves valuable space on a display screen which can be small and reduced size display screen of a mobile client computer device. The described formatting also avoids any perception of a temporal or linear progression from left to right caused by a rectangular unfolded multidimensional relationship diagram 202. Diagram 202 accurately shows the two way relationship between the subsets of the categories without suggested hierarchy or linear or temporal progression.

FIG. 5 presented using the Table D dataset illustrates a simplified use case of a restaurant that serves platters wanting to track how many meals are served at breakfast, lunch and dinner, how many meals are kids meals, senior citizen meals or regular meals, and how many meals came with water, soda or tea. The restaurant wants to track comparisons between these categories to know how many breakfasts were also kids meals, etc.

FIG. 5 presented using the Table D dataset shows the relationship between the all the subcategories of each category to all the subcategories of each other category, but it makes the meal time the highest priority by having it first, repeats meal time in order to show it's relationship to beverages, and hints toward a linear flow from left to right which is often used to show a temporal relationship between categories.

FIG. 5 presented using the Table D dataset fans out the multidimensional relationship diagram until the two meal time category bar charts overlap, the same information can be rendered without the problems of the first simple multidimensional relationship shown in FIG. 5. With this method of rendering data, the user is limited to three categories, but can present and compare as many or as few subcategories with one another as needed. While various advantages of folded multidimensional relationship diagram 202 over rectangular unfolded multidimensional relationship diagram 203 are described it is understood that rendering of rectangular unfolded multidimensional relationship diagram 203 can feature advantages as well (e.g. making use of rectangular render space, illustration of temporal relationships where they exist) and can be preferred under certain scenarios.

Bars P1A-P3C of folded multidimensional relationship diagram 202 can have bar lengths proportional to quantities associates to the bars as set forth herein and segments 1206 can widths that are proportional to quantities associated to the segments. For example, where a segment 1206 connects first and second bars associated to first and second condition parameter values of first and second condition parameters, the segment width can be proportional to a quantity associated to the segment, e.g. the quantify of members represented by the multidimensional relationship diagram that have both the first condition parameter value of the first condition parameter, and the second condition parameter value of the second condition parameter.

In folded multidimensional relationship diagram 202, a third set of segments connecting a second set of bars to a first set of bars is provided without duplicating presentment of the first set of bars. In folded multidimensional relationship diagram 202 because of its configuration, duplication of a set of bars can be avoided and each of the three sets of bars each associated with a different configuration parameter can be presented only once, thereby conserving space on display screen 1202 which can be of reduced size, e.g. can be included on a hand held mobile smartphone.

Folded multidimensional relationship diagram 202 according to one embodiment can be circular in form, e.g. can be provided so that segments 1206 connecting first bars of each set of bars define a circular shape as shown in folded multidimensional relationship diagram 202 of FIG. 1. Folded multidimensional relationship diagram 202 can define a circular shape but need not define a precise circle. Folded multidimensional relationship diagram can be circular, e.g., can be (a) of a precise circle shape having a perimeter precisely evenly spaced from a center, or can be (b) generally curved or rounded, e.g. oval, or polygonal with a perimeter defining sides of sufficient number to resemble a precise circle.

According to one embodiment as shown in FIG. 1, some segments 1206, e.g. the outer most segments can be defined by precise circle fragments while other segments 1206 can be merely curved without defining a precise circle fragment. According to one embodiment segments 1206 of folded multidimensional relationship diagram 202 can include only circular curved segments that do not define precise circle fragments. In other embodiments segments 1206 can include a combination of segments that define precise circle fragments and segments that do not define precise circle fragments. In other embodiments, segments 1206 can consist of or include noncircular and/or nonrounded segments but which in combination define a folded multidimensional relationship diagram circular in shape. According to another feature of folded multidimensional relationship diagram 202, each of the bar sets namely, first bar set P1A-P1C, second bar set P2A-P2C, and third bar set P3A-P3C, can be symmetrically disposed in relation to center so that a spacing distance (at any certain distance from a multidimensional relationship diagram center) between a common axis of first set of elongated bars and a common axis of second set of elongated bars is equal to a spacing distance between a common axis of a second set of elongated bars and a common axis of a third set of elongated bars, which is equal to a spacing distance between the common axis of the third set of bars and the common axis of the first set of elongated bars. The symmetrical presentment of the bar sets further avoids the presentment of hierarchy or linear progression as in the case of a rectangular multidimensional relationship diagram 203 as depicted in FIG. 5.

Referring to user interface 1201 as shown in FIG. 1, a user can activate control 1218. In response to activation of control 1218 grid data can be presented on user interface 1201, as depicted in FIG. 6. Grid data as shown in FIG. 6 can be the data that can be graphically and interactively depicted with use of a folded multidimensional relationship diagram 202 or a rectangular multidimensional relationship diagram 203.

In a multidimensional relationship diagram as shown by rectangular multidimensional relationship diagram 203 (FIG. 1) and folded multidimensional relationship diagram 202 (FIG. 5) the width of segments 1206 can have significance and can depict the strength or weakness of a relationship between condition parameter values. The width of each segment 1206 can indicate the quantity (e.g. count or percentage) of members having the condition parameter value associated to a first bar and a condition parameter value associated to a second bar.

For example, segment 1206 at F connects bar P1A associated to the condition parameter value according to one embodiment of high CPU utilization, and bar P2A associated with the condition parameter value of GPU utilization. That means that the quantity of members (in this case computing nodes) that exhibit both of the conditions of high CPU utilization and high GPU utilization has a value indicated by the width of segment 1206 at location “F”. Segment 1206 at location “F” indicating 5 computing nodes that have high CPU utilization and high GPU utilization can have 5 times the width of an alternative hypothetical segment 1206 indicating that there is only one computing node that has both high CPU utilization and high GPU utilization (utilization levels above respective high thresholds).

FIG. 7 illustrates user interface 1201 rendered on a display screen 1202 that includes folded multidimensional relationship diagram 202 in a baseline view without highlight of any segments of folded multidimensional relationship diagram 202. A user can interact with folded multidimensional relationship diagram 202 for facilitation of AI decisions and for providing of outputs for presentment to a visualization control interface and/or one or more process control interface.

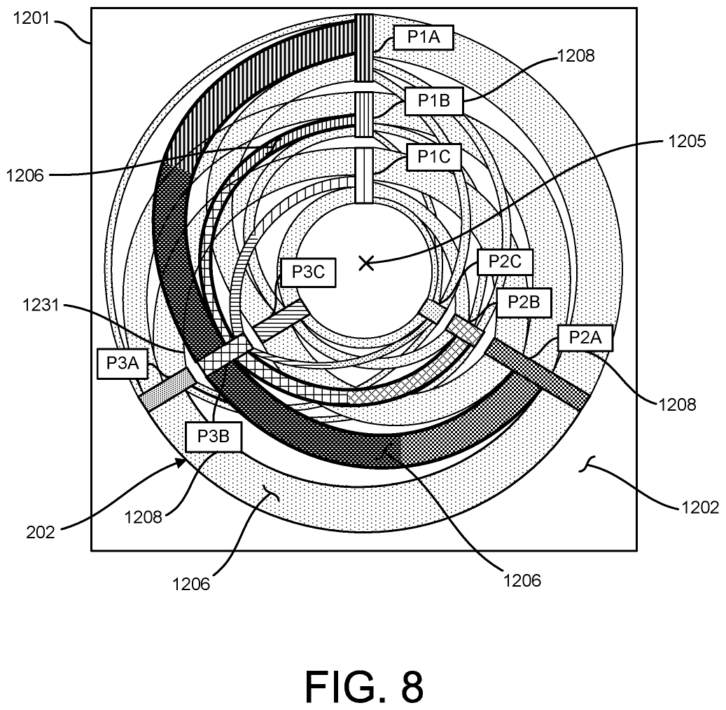

FIGS. 8-11 illustrate advanced user interface functionality, in which data decisions and/or outputs for presentment to process interfaces can be provided in response to receipt of user defined inputs input into user interface 1201.

FIG. 8 illustrates a highlighting of segments 1206 that can occur in response to double pressing and holding of a certain bar, e.g. bar P3B. In response to the double pressing and holding of bar P3B, each of the three segments 1206 connecting bar P3B to bars P1A-P1C, each of the segments 1206 connecting bar P3B to bars P2C-P2A can be highlighted. FIG. 8 illustrates the case where there is a double press in area 1231 associated to bar P3B. The functionality of claim 8 according to one embodiment facilitates quick identification of computing nodes having medium memory utilization, and levels of CPU utilization, and GPU utilization of such computing nodes.

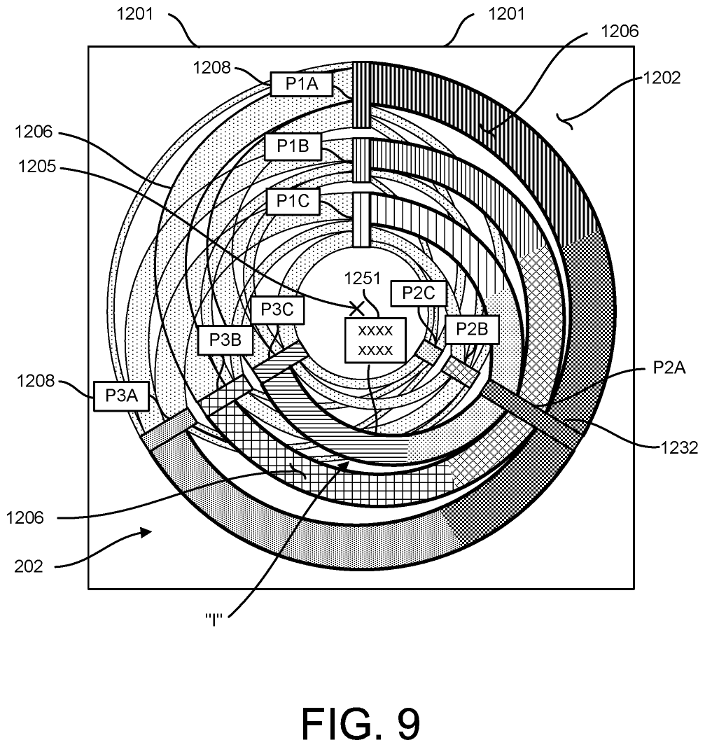

FIG. 9 illustrates the use case according to one embodiment where there is a double press and hold of bar P2A, e.g. by a user double pressing and holding P2A. In the case where a user double presses and holds bar P2A to provide a certain user defined input, each rendered segment 1206 connecting bar P2A to bars P1A-P1C and each rendered segment 1206 connecting bar P2A to bars P3A-P3C can be highlighted so as to be distinguished from remaining segments 1206 rendered in user interface 1201. According to the use case described involving the dataset of Table A double pressing and holding bar P2A can facilitate the quick rendering of identifiers for computing nodes having high GPU utilization and levels of CPU utilization and memory utilization of such nodes.

As depicted by area 1251 in FIG. 9, interaction by a user with rendered folded multidimensional relationship diagram 202 of a user interface can result in one or more output being provided other than a highlight of segments 1206. For example, in response to the described activation of bar P2A, area 1251 can be presented which in the case of an IT management data implementation can present an identification of computing nodes that share the parameter condition values associated to the segment connected to the segment at location “I” associated to area 1251. That is, in area 1251 associated to the segment 1206 at “J” there can be rendered identifiers of computing nodes that share the condition parameter value indicated by bar P3C and the condition parameter value indicated by bar P2A. Likewise, in the case that a dataset represents people, e.g. in the case of Tables C or D, area 1251 can include text depicting identifiers of human individuals exhibiting the condition parameter values indicated by bar P3C and bar P2A. Indicating areas such as area 1251 for each highlighted segment 1206 of user interface 1201 depicted in FIG. 9 can be provided for each segment that is highlighted as a result of a user defined input, e.g. in the case of FIG. 9 by double pressing and holding of bar P2A.

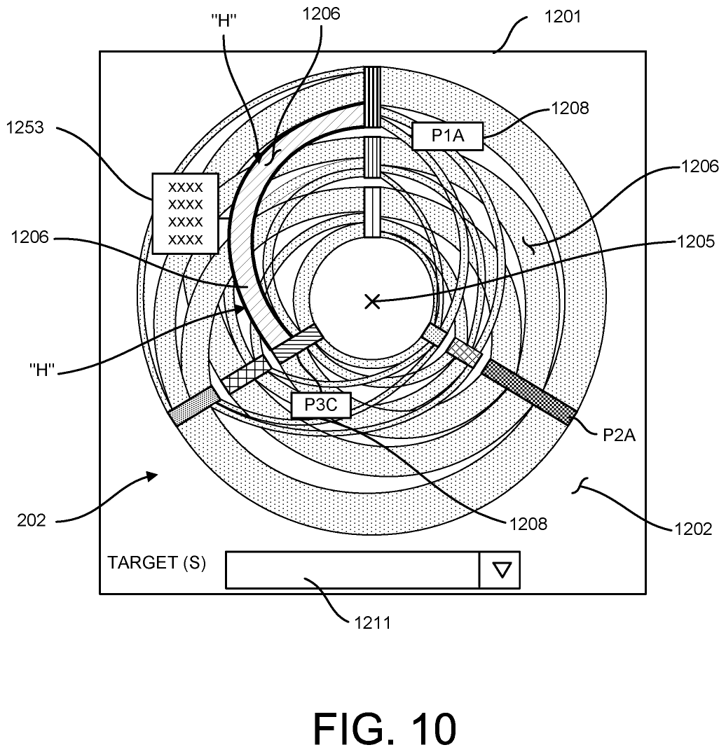

FIG. 10 illustrates the user input response functionality described in FIG. 1 relative to bar P1A and bar P3C being pressed simultaneously by a user with further enhanced functionality to result in rendering of text area 1253 and further functionality to auto provision computing nodes based on the interaction of a use with the rendered folded multidimensional relationship diagram 202.

Referring to FIG. 10, a user can press and hold with first and second fingers bar P1A and bar P3C simultaneously. User interface 1201 can be configured so that in response to bar P1A and bar P3C being simultaneously pressed and held, segment 1206 connecting bar P3C and bar P1A at location “H” can be highlighted, e.g. rendered in a different color, brightness, density, depth, etc. relative to remaining segments 1206 of folded multidimensional relationship diagram 202.

Further in response to the simultaneous pressing with first and second fingers, e.g. a thumb and a forefinger on bar P3C and bar P1A, area 1253 can be rendered. Area 1253 can include a text based list that specifies computing nodes that commonly have the characteristics indicated by bars P3C and P1A, e.g. have the condition parameter value associated to bar P3C and the condition parameter value associated to bar P1A. In the described example described with reference to Table A (IT management dataset data) area 1253 can specify a text based list of identifiers of computing nodes that have the condition parameter value associated to bar P3C (low memory utilization) and also have the condition parameter value associated to bar P1A (high CPU utilization). It will be seen that a user using folded multidimensional relationship diagram 202 as depicted in FIG. 10 can press bars P3C and P1A simultaneously when the user wants to identify computing node quantities and identifiers of computing nodes that commonly have high CPU utilization and low memory utilization.

According to another feature that can be implemented with use of user interface 1201, manager system 110 can be configured to automatically provision computing nodes that are specified in area 1211 of user interface 1201 in accordance with the provisioning of computing nodes depicted in an area such as area 1253 associated to a line segment that connects first and second user selected bars, such as bar P3C and par P1A in the foregoing example. Also it will be seen using user interface 1201, a user can activate e.g. by pressing certain first and second bars of rendered folded multidimensional relationship diagram 202 to identify members such as computing nodes having desirable combinations features, (e.g. high CPU utilization and low memory utilization according to one use case) to identify well performing computing nodes and to automatically provision selected targeted computing nodes to be provisioned in accordance with the identified computing nodes that identified by user interaction with rendered folded multidimensional relationship diagram 202.

In area 1211, a user can specify IP addresses of targeted computing nodes within services system 160 e.g. with or without a dropdown menu. User interface 1201 can be configured so that a user can confirm a selection to trigger auto provisioning, e.g. can be configured so that a user can confirm the auto provisioning of a selected target one or more computing node by double pressing area 1253, and auto-provisioning proceeds in response to the double pressing and some cases the auto-provisioning is not dependent on the double pressing (auto-provisioning proceeds without a double press). In some cases, area 1253 can specify identifiers for more than one computing node. In such a situation the provisioning that is selected can be based, e.g. on the first listed identifier, the provisioning common to the greatest number of identifiers or the specific identifier within area 1253 that is selected by a user (a user can select a specific subarea within area 1253 specific to one computing node identifier).

In response to the triggering of provisioning according to one embodiment (conditional or not conditional on an actuation of area 1253), manager system 110 can copy provisioning data of a computing node specified within area 1253 and write the provisioning data to a specified one or more target computing node specified within area 1211 for installation on the one or more target computing node. Provisioning data can include, e.g. one or more full stack hypervisor based virtual machine, one or more full stack container based virtual machine, or other types of provisioning data.

Manager system 110 according to one embodiment can maintain a code repository 2122 within data repository 112. Code repository 2122 in addition to storing provisioning data, e.g. images for the instantiation of hypervisor based virtual machines and container based virtual machines can include a reference list that associates computing node identifiers of services system 160 to identifiers of provisioning data associated to the computing nodes of services system 160. In response to the triggering of provisioning according to one embodiment, manager system 110 can copy provisioning data code repository that is specified in the reference list as matching the provisioning of a computing node specified within area 1253 and can write the provisioning data to a specified one or more target computing node specified within area 1211 for installation on the one or more target computing node. Provisioning data can include, e.g. one or more full stack hypervisor based virtual machine, one or more full stack container based virtual machine, or other types of provisioning data.

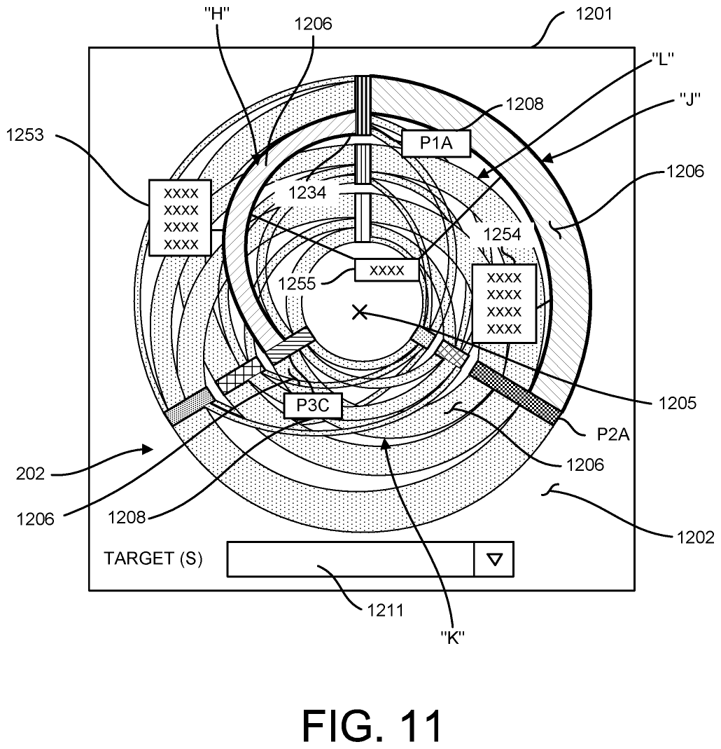

FIG. 11 illustrates the use case where folded multidimensional relationship diagram 202 of user interface 1201 is used in a manner so that there is selection of a third bar P2A in addition to bars P3C and P1A as depicted in FIG. 10. In FIG. 10, the use case is depicted where a user can use folded multidimensional relationship diagram 202 to identify computing nodes having desirable according to one scenario first and second characteristics of having high CPU utilization and low memory utilization. Referring to FIG. 11, by simultaneous selection of bar P2A, folded multidimensional relationship diagram 202 further facilitates the selection and identification of computing nodes that have high GPU utilization in addition to having high CPU utilization and low memory utilization.

Manager system 110 can be configured so that the features depicted in FIG. 11 are activated when bars P3C, P1A, and P2A are simultaneously pressed. For example, a user can use a thumb and a forefinger of a left hand to simultaneously press bar P3C and bar P1A and can use a thumb and a forefinger of a right hand to simultaneously press bar P2A and P1A.

User interface 1201 can be configured so that when bar P3C, P1A, and P2A are simultaneously pressed, areas 1253, 1254, and 1255 can be simultaneously rendered. Area 1253 can render text based computing node identifiers having the characteristics depicted by segment 1206 at location “H” connecting bar P3C and bar P1A, i.e. as explained with reference to FIG. 10 can specify computing nodes that have both low memory utilization and high CPU utilization (the condition parameter values associated to bar P3C and P1A respectively).

Area 1254 can specify a list of computing node identifiers that have the characteristics depicted by segment 1206 at location “J”; namely, computing nodes that exhibit both high CPU utilization (condition parameter value associated to bar P1A) and which have high GPU utilization (condition parameter value associated to bar P2A) according to the described example referencing the dataset of Table A.

User interface 1201 as shown in FIG. 11 can be configured further so that responsively to bars P3C, P1A, and P2A being simultaneously pressed, area 1255 can be rendered. In area 1255 there can be rendered text based specifiers, e.g. text based identifiers of computing nodes commonly having characteristics depicted by segment 1206 at location “H” and by segment 1206 at location “J”. Namely, can depict specifiers for computing nodes that commonly have high CPU utilization (bar P1A) low memory utilization (bar P3C) and high GPU utilization (bar P2A). Area 1255 can specify a shorter list of computing nodes than are specified in areas 1253 or 1255. Area 1255 in the use case described can specify one or more computing node that has been identified via user interaction with folded multidimensional relationship diagram 202 and which exhibit the highly desirable simultaneous characteristics, according to one use case scenario of having high CPU utilization, high GPU utilization, and low memory utilization.

Manager system 110 can be configured so that in response to pressing of bars P3C, P1A, and P2A simultaneously (e.g. with bar P1A being pressed with two different fingers simultaneously) to define a certain input of a user, manager system 110 automatically provisions target computing nodes specified in area 1211 in accordance with the provisioning of a computing node specified in area 1255. Computing nodes specified in area 1211 can be specified with or without use of a dropdown menu. In the case that area 1255 specifies an identifier of more than one computing node, rules based criteria can be consulted for selection of one computing node, e.g. can be selected based on the top listed computing node, the most common provisioning amongst computing nodes listed, or a subset of area 1255 activated by a user (area 1255 can be configured so that subareas specific to one identifier within area 1255 can be selected). Manager system 110 can be configured so that provisioning of the targeted one or more computing node confirmed and proceeds conditionally in response to actuation of area 1255, e.g. finger pressing of area 1255 after it has been rendered.

In response to the triggering of provisioning (which can be conditional or not conditional on actuation of area 1255), manager system 110 can copy provisioning data of a computing node specified within area 1255 and write the provisioning data to a specified one or more target computing node specified within area 1211 for installation on the one or more target computing node. Provisioning data can include, e.g. a full stack hypervisor based virtual machine, a full stack container based virtual machine, or other types of provisioning data.

Manager system 110 according to one embodiment can maintain a code repository 2122 within data repository 112. Code repository 2122 in addition to storing provisioning data, e.g. images for the instantiation of hypervisor based virtual machines and container based virtual machines can include a reference list that associates computing node identifiers of services system 160 to identifiers of provisioning data associated to the computing nodes of services system 160. In response to the triggering of provisioning according to one embodiment, manager system 110 can copy provisioning data code repository that is specified in the reference list as matching the provisioning of a computing node specified within area 1255 and can write the provisioning data to a specified one or more target computing node specified within area 1211 for installation on the one or more target computing node. Provisioning data can include, e.g. one or more full stack hypervisor based virtual machine, one or more full stack container based virtual machine, or other types of provisioning data.

User interface 1201 can be configured according to one embodiment so that segment 1206 at location “H” is highlighted simultaneously with the highlighting of segment 1206 at location “J”, only in the case that there is a simultaneous pressing of bar P3C, P2A, and P1A with a two finger (e.g. left hand finger and right hand finger) pressing of bar P1A (and not merely a single finger pressing of bar P1A). Such rule can be implemented so that the user is free to select an alternative segment with a right hand finger, such as segment 1206 at location “K” or “L” and to allow manager system 110 to discriminate between an intended selection of segment 1206 at location “J” and location “K” or location “L” respectively (both segment 1206 at “J” and segment 1206 at K″ are connected between bar P2A and a bar that is connected to segment 1206 at “H”.

It will be understood that rendered folded multidimensional relationship diagram 202 can be used to trigger auto-provisioning in a wide range of IT management scenarios. With use of configuration user interface 1301 (FIG. 4) a user can reconfigure bars P2A-P2C (or another set of bars) so that bars P2A-2C are associated with another condition parameter available from IT management system 2604 and not the condition parameter of GPU. P2A-P2C can be reconfigured as bars P2A-P2B to be associated to the condition parameter values “healthy” and “unhealthy” and the combined three bar selections of FIG. 11 can represent instead the selections of high CPU utilization (bar P1A selection), with low memory utilization (bar P3C selection), and “healthy” (bar P2A selection). A user can use folded multidimensional relationship diagram 202 to auto-provision targeted computing nodes specified in area in accordance with the provisioning of computing nodes that have high CPU utilization, which are healthy and have low memory utilization. Manager system 110 can be configured using user interface 1301 so that bars P1A-P3C are associated to any selected combination of condition parameters possible based on data received from and IT management system 2604.

Where the bars P1A-P3A are configured using the configuration parameters of Table C, selection of multiple bars can identify computing nodes in area 1255 for use in auto-provisioning which feature various other combinations of shares condition parameter values, (e.g. computing nodes which at once have high utilization, which consume available storage, and which are unhealthy.

Auto-provisioning herein can include reconfigurations of resources that include deletion of program data. While it can be seen that folded multidimensional relationship diagram 202 can be used for the expedited identification of resources that are well functioning, folded multidimensional relationship diagram 202 can also be used for the identification of resources that are regarded to be poorly functioning. For example, in the described example of the Table A dataset, bars P1C, P2C, and P3A can be pressed simultaneously to identify computing nodes that at once have low CPU utilization, low GPU utilization, and high memory utilization (which can be regarded to be poorly functioning according to one selected design criterion). Manager system 110 can be configured so that in response to an alternative control activation received from a user interacting with area 1255 (e.g. a press and hold instead of a press), manager system 110 can auto delete provisioning data of the computing nodes identified by text based computing node identifiers rendered in area 1255.

Manager system 110 can provide various outputs e.g. to a visualization control interface for rendering data (e.g. graphical and/or textual) on a display screen and/or to a process control interface other than a visualization control interface in response to activation of bars P1A-P3C, e.g. a process control interface for provisioning one or more resource.

Activation of bars has been described with reference to finger pressing of a user. According to another embodiment, bars as set forth herein can additionally or alternatively be activated by clicking with use of a pointer controller e.g. a mouse or other type of pointer controller. Further, manager system 110 can additionally or alternatively provide outputs in response to activation of segments 1206. For example, in reference to FIG. 9, activation of bar P2A can result in highlighting in all segments 1206 connected to bar P2A. Manager system 110 can be configured so that with the segment 1206 in a highlighted state activation e.g. by pressing of the segment 1206 at “J” can result in area 1251 being rendered. In reference to FIG. 10, simultaneous activation of bar P1A and bar P3C can result in segment 1206 at “H” being highlighted. Manager system 110 can be configured so that with segment 1206 at “H” in a highlighted state, a first input applied by activation of segment 1206 at “H” (e.g. a single press) can result in rendering of area 1253, a second input applied by activation of segment 1206 at “H” (e.g. a double press following a single press) can result in auto-provisioning by copying of provisioning data of a computing node identified in area 1253 into a computing node identified in area 1211, and a third input applied by activation of segment 1206 at “H” (e.g. a long press following a single press) can result in auto-provisioning by deletion of provisioning data of a computing node identified in area 1253.

In reference to FIG. 10, simultaneous activation of bar P1A bar P2A and P3C can result in segment 1206 at “H” and segment 1206 at “J” being highlighted. Manager system 110 can be configured so that with segment 1206 at “H” and segment 1206 at “J” in a highlighted state, a first input applied by activation of segment 1206 at “H” and segment 1206 at “J” (e.g. pressing both the segments simultaneously) can result in rendering of area 1255, a second input applied by activation of area (e.g. a double press of area 1255) can result in auto-provisioning by copying of provisioning data of a computing node identified in area 1255 into a computing node identified in area 1211, and a third input applied by activation of area 1255 (e.g. a long press) can result in auto-provisioning by deletion of provisioning data of a computing node identified by text in area 1255.

Certain embodiments herein may offer various technical computing advantages involving computing advantages to address problems arising in the realm of computer devices and systems. Embodiments herein can feature advanced user interface features for optimized use on mobile computer devices having display screens of reduced size. User interface features herein can improve data decisions including human-aided machine decisions and machine-aided human decisions. Embodiments herein aid in the identification of entities such as computing nodes having defined performance condition attributes. Certain embodiments herein are particularly useful in an IT management environment involving the processing of data from an IT management system. Embodiments herein recognize that administrators in IT environments are increasingly mobile and multitasking. Embodiments herein featuring an improved user interface rendered on mobile client computer device having a reduced size display screen can improve human-aided machine decisions and machine-aided human decisions wherein a human user is any type of use including e.g. an IT administrator user who is using a mobile client computer device and in some cases more than one client computer device simultaneously for the performance of multiple tasks. Embodiments herein can include rendering of a folded multidimensional relationship diagram which facilitates identification of assets and problems and avoids erroneous decisions involving, e.g. deduced hierarchies among condition parameter categories, linear progression, and/or time progression. Embodiments herein can include auto provisioning targeted computing nodes based on user interaction with rendered graphics.

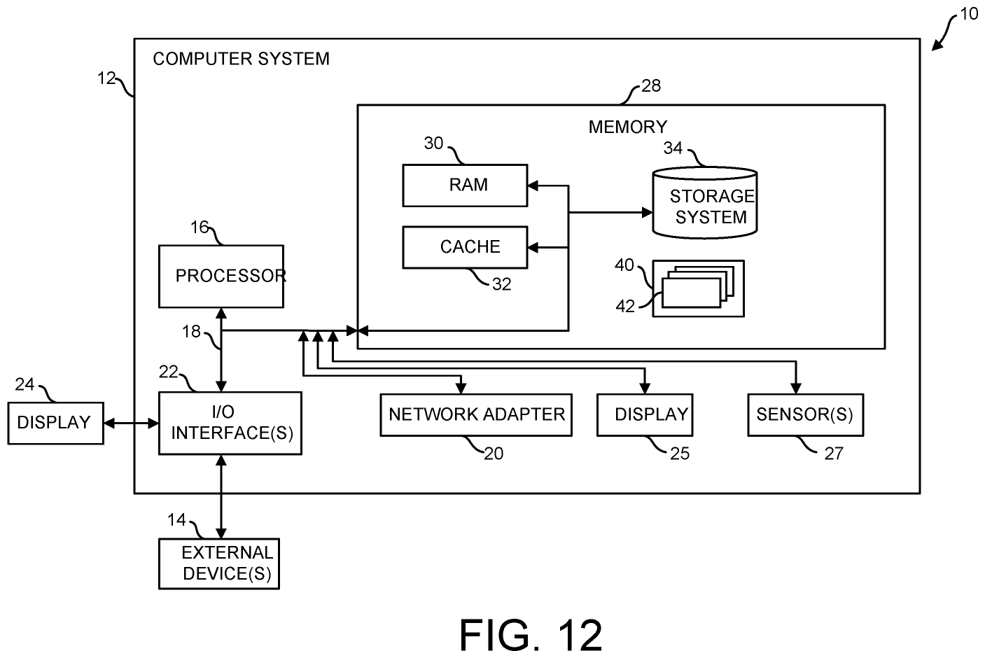

FIGS. 12-14 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 12, a schematic of an example of a computing node is shown. Computing node 10 is only one example of a computing node suitable for use as a cloud computing node and is not intended to suggest any limitation as to the scope of use or functionality of embodiments of the invention described herein. Regardless, computing node 10 is capable of being implemented and/or performing any of the functionality set forth hereinabove. Computing node 10 can be implemented as a cloud computing node in a cloud computing environment, or can be implemented as a computing node in a computing environment other than a cloud computing environment.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

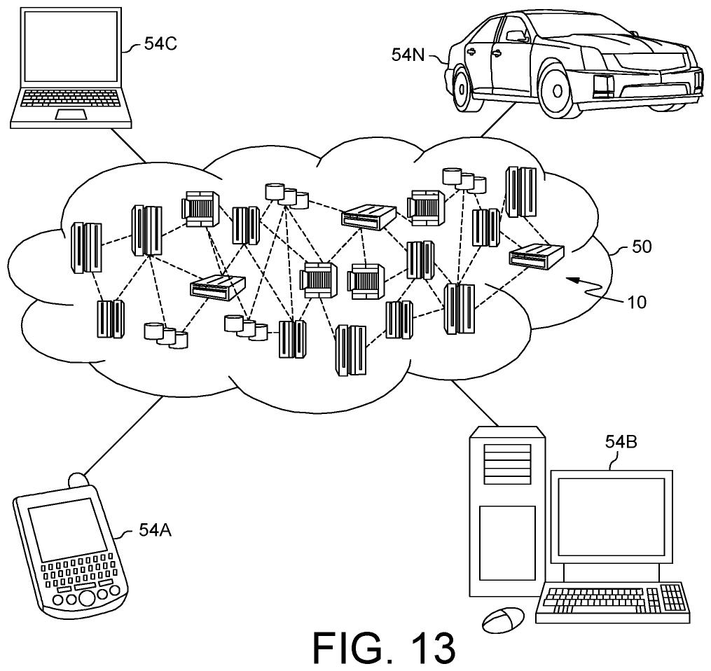

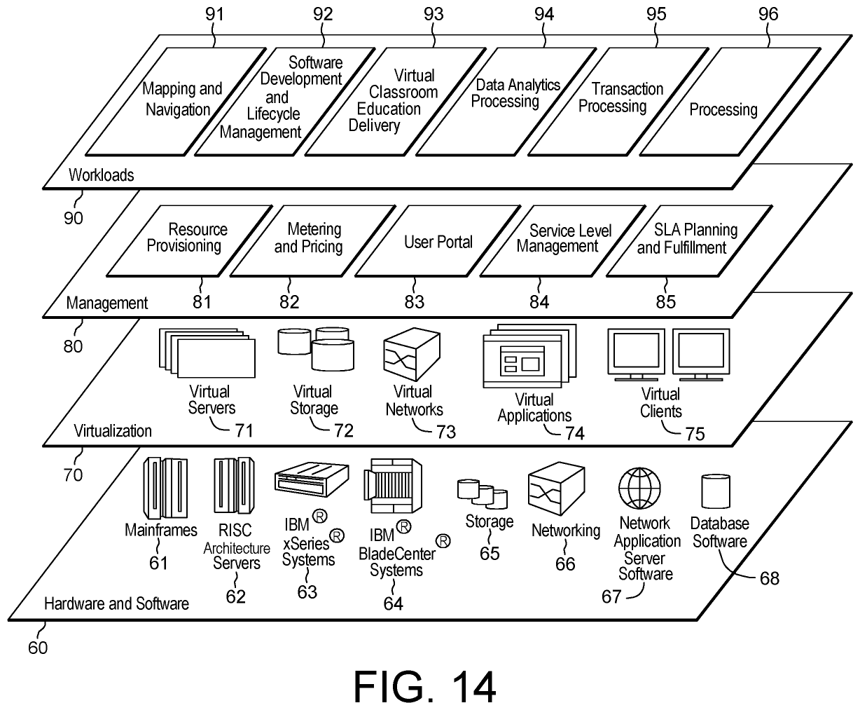

As shown in FIG. 12, computer system 12 in computing node 10 is shown in the form of a computing device. The components of computer system 12 may include, but are not limited to, one or more processor 16, a system memory 28, and a bus 18 that couples various system components including system memory 28 to processor 16. In one embodiment, computing node 10 is a computing node of a non-cloud computing environment. In one embodiment, computing node 10 is a computing node of a cloud computing environment as set forth herein in connection with FIGS. 13-14.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. One or more program 40 defines machine logic. One or more program 40 including program processes 42 can generally carry out the functions set forth herein. In one embodiment, manager system 110 can include one or more computing node 10 and can include one or more program 40 for performing functions described with reference to method 300 of FIG. 3 and remaining functions described with reference to manager system 110 set forth herein. In one embodiment, the computing node based systems and devices depicted in FIG. 2 can include one or more program 40 for performing functions described with reference to such computing node based systems and devices.

Computer system 12 may also communicate with one or more external devices 14 such as a keyboard, a pointing device, a display screen 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display screen 24, which can be configured to provide user interface functionality, computing node 10 in one embodiment can include display screen 25 connected to bus 18. In one embodiment, display screen 25 can be configured as a touch screen display and can be configured to provide user interface functionality, e.g. can facilitate virtual keyboard functionality and input of total data. Computer system 12 in one embodiment can also include one or more sensor device 27 connected to bus 18. One or more sensor device 27 can alternatively or additionally be connected through I/O interface(s) 22. One or more sensor device 27 can include a Global Positioning Sensor (GPS) device in one embodiment and can be configured to provide a location of computing node 10. In one embodiment, one or more sensor device 27 can alternatively or in addition include, e.g., one or more of a camera, a gyroscope, a temperature sensor, a humidity sensor, a pulse sensor, a blood pressure (bp) sensor or an audio input device. Computer system 12 can include one or more network adapter 20. In FIG. 13 computing node 10 is described as being implemented in a cloud computing environment and accordingly is referred to as a cloud computing node in the context of FIG. 13.

Referring now to FIG. 13, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

Referring now to FIG. 14, a set of functional abstraction layers provided by cloud computing environment 50 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for rendering of user interfaces having relationship diagrams and responding to user interactions therewith as set forth herein. The processing components 96 can be implemented with use of one or more program 40 described in FIG. 12.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A method comprising:
rendering on a display screen a folded multidimensional relationship diagram, wherein the folded multidimensional relationship diagram includes first, second, and third stacks of active bars associated respectively to first, second and third condition parameters, wherein respective bars of first stack of active bars are associated to respective condition parameter values of the first condition parameter, wherein respective bars of second stack of active bars are associated to respective condition parameter values of the second condition parameter, wherein respective bars of third stack of active bars are associated to respective condition parameter values of the third condition parameter, wherein the folded multidimensional relationship diagram includes a first segment set that connects bars of the first stack of active bars to bars of the second stack of active bars, a second segment set that connects bars of the second stack of active bars to bars of the third stack of active bars, and a third segment set that connects bars of the third stack of active bars to bars of the first stack of active bars;
receiving one or more input from a user, the one or more input being in dependence on a user's interaction with the folded multidimensional relationship diagram rendered on the display screen; and
providing one or more output in dependence on the one or more input received from the user.

2. The method of claim 1, wherein the first, second and third condition parameters are obtained using an IT management system, wherein the first second and third condition parameters are condition parameters of computing nodes of a computer system, wherein the one or more output includes an output to render a text based identifier of a computing node, and wherein the one or more output includes an output to provision a resource of the computer system.

3. The method of claim 1, wherein the first, second and third condition parameters are obtained using an IT management system, wherein the first second and third condition parameters are condition parameters of computing nodes of a computer system, wherein the one or more output includes an output to render a text based identifier of a computing node in response to the user simultaneously pressing a first bar of the first stack of active bars, a second bar of the second stack of active bars, and a third bar of the third stack of active bars, the computing node specified by the text based identifier having a first condition parameter value of a first condition parameter associated to the first bar, a second condition parameter value of a second condition parameter associated to the second bar, and a third condition parameter value of a third condition parameter associated to the first bar, and wherein the one or more output includes an output to provision a resource of the computer system.

4. The method of claim 1, wherein the first, second and third condition parameters are obtained using an IT management system, wherein the first second and third condition parameters are condition parameters of computing nodes of a computer system, wherein the one or more output includes an output to render a text based identifier of a computing node in response to the user simultaneously pressing a first bar of the first stack of active bars, a second bar of the second stack of active bars, and a third bar of the third stack of active bars, the computing node specified by the text based identifier having a first condition parameter value of a first condition parameter associated to the first bar, a second condition parameter value of a second condition parameter associated to the second bar, and a third condition parameter value of a third condition parameter associated to the first bar, and wherein the one or more output includes an output to perform provisioning of a targeted node of the computer system, the targeted node being specified by a user using a user interface on which the folded multidimensional relationship diagram is rendered, the provisioning including copying provisioning data of the computing node specified in the text based list and installing the provisioning data onto the targeted node.

5. The method of claim 1, wherein the first, second and third condition parameters are obtained using an IT management system, wherein the first second and third condition parameters are condition parameters of computing nodes of a computer system, wherein the one or more output includes an output to render a text based identifier of a computing node in response to the user simultaneously pressing a first bar of the first stack of active bars, a second bar of the second stack of active bars and a third bar of the third stack of active bars, the computing node specified by the text based identifier having a first condition parameter value of a first condition parameter associated to the first bar, a second condition parameter value of a second condition parameter associated to the second bar, and a third condition parameter value of a third condition parameter associated to the first bar, and wherein the one or more output includes an output to provision a resource of the computer system, wherein the method includes detecting that first and second fingers of the user have pressed the first bar, and wherein the method includes rendering the text based list based on the detecting that the first bar has been pressed by the first and second fingers of the user.

6. The method of claim 1, wherein a length of a certain bar of the first stack of active bars is proportional to a quantity of members having a condition parameter value associated to the certain bar.

7. The method of claim 1, wherein a width of a certain segment connecting a first bar of the first stack of active bars to a second bar of the second set of active bars is proportional to a quantity of members having a first condition parameter value associated to the first bar and a second condition parameter associated to the second bar.

8. The method of claim 1, wherein a width of a certain segment connecting a first bar of the first stack of active bars to a second bar of the second set of active bars is proportional to a quantity of certain members having a first condition parameter value associated to the first bar and a second condition parameter associated to the second bar, wherein the method includes highlighting the certain segment in response to the user activating the certain segment, and wherein the method includes rendering a text based list of the certain members in response to the user activating the certain segment.

9. The method of claim 1, wherein the condition parameters are computer system condition parameters obtained from a IT management system, wherein the method includes rendering, in response to receiving at least one input of the one or more input, a text based list of identifiers of resources of a computer system having a first condition parameter value associated to a first bar of the first stack of active bars and a second condition parameter value associated to a second bar of the second stack of active bars, and wherein the one or more output includes one or more output to provision a resource identified in the text based list of identifiers, wherein the rendering includes rendering the folded multidimensional relationship diagram on a display screen of a hand held mobile computer device.

10. The method of claim 1, wherein the first second and third condition parameters are condition parameters of computer system computing nodes, wherein a width of a certain segment connecting a first bar of the first stack of active bars to a second bar of the of the second stack of active bars is proportional to a quantity of certain computing nodes having a first condition parameter value associated to the first bar of the first stack of active bars and a second condition parameter associated to the second bar of the second stack of active bars, wherein the method includes highlighting the certain segment in response to the user activating the certain segment, and wherein the method includes rendering a text based list specifying the certain computing nodes in response to the user activating the certain segment, the activating the certain segment including pressing the certain segment.

11. The method of claim 1, wherein the first second and third condition parameters are condition parameters of computer system computing nodes, wherein a width of a certain segment connecting a first bar of the first active stack of bars to a second bar of the second stack of active bars is proportional to a quantity of computing nodes having a first condition parameter value associated to the first bar and a second condition parameter associated to the second bar, wherein the method includes highlighting the certain segment in response to the user activating the certain segment, and wherein the method includes rendering a text based list of the computing nodes in response to the user activating the certain segment, and wherein the method includes provisioning a target node specified by the user in accordance with a provisioning of a specified node that is specified in the text based list.

12. The method of claim 1, wherein the method includes rendering an unfolded multidimensional relationship diagram in response to a user input.

13. The method of claim 1, wherein the one or more output includes an output to highlight a first segment of the folded multidimensional relationship diagram, and an output to highlight a second segment of the folded multidimensional relationship diagram, and an output to render a text based list that specifies members commonly associated to the first segment and the second segment.

14. The method of claim 1, wherein the one or more input includes pressing a first bar of a first bar stack and pressing a second bar of a second bar stack simultaneously, and wherein the one or more output includes an output to highlight a segment connecting the first bar and the second bar.

15. The method of claim 1, wherein each of the first second and third bar stacks has bars that are arranged end to end lengthwise with spaces therebetween, wherein each of the first second and third stacks of active bars is arranged non-parallel to each other stack of active bars, and wherein each of the first, second, and third stack of active bars points to a center of the folded multidimensional relationship diagram, the multidimensional relationship diagram being a circular multidimensional relationship diagram.

16. A computer program product comprising:
a computer readable storage medium readable by one or more processing circuit and storing instructions for execution by one or more processor for performing a method comprising:
rendering on a display screen a folded multidimensional relationship diagram, wherein the folded multidimensional relationship diagram includes first, second, and third stacks of active bars associated respectively to first, second and third condition parameters, wherein respective bars of first stack of active bars are associated to respective condition parameter values of the first condition parameter, wherein respective bars of second stack of active bars are associated to respective condition parameter values of the second condition parameter, wherein respective bars of third stack of active bars are associated to respective condition parameter values of the third condition parameter, wherein the folded multidimensional relationship diagram includes a first segment set that connects bars of the first stack of active bars to bars of the second stack of active bars, a second segment set that connects bars of the second stack of active bars to bars of the third stack of active bars, and a third segment set that connects bars of the third stack of active bars to bars of the first stack of active bars;
receiving one or more input from a user, the one or more input being in dependence on a user's interaction with the folded multidimensional relationship diagram rendered on the display screen; and
providing one or more output in dependence on the one or more input received from the user.

17. The computer program product of claim 17, wherein the first second and third condition parameters are condition parameters of computer system computing nodes, wherein a width of a certain segment connecting a first bar of the first active stack of bars to a second bar of the second stack of active bars is proportional to a quantity of computing nodes having a first condition parameter value associated to the first bar and a second condition parameter associated to the second bar, wherein the method includes highlighting the certain segment in response to the user activating the certain segment, and wherein the method includes rendering a text based list of the computing nodes in response to the user activating the certain segment, and wherein the method includes provisioning a target node specified by the user in accordance with a provisioning of a specified node that is specified in the text based list.

18. The computer program product of claim 17, wherein the condition parameters are computer system condition parameters obtained from a IT management system, wherein the method includes rendering, in response to the receiving at least one input of the one or more input, a text based list of identifiers of resources of a computer system having a first condition parameter value associated to a first bar of the first stack of active bars and a second condition parameter value associated to a second bar of the second stack of active bars, and wherein the one or more output includes one or more output to provision a resource identified in the text based list of identifiers, wherein the rendering includes rendering the folded multidimensional relationship diagram on a display screen of a hand held mobile computer device, wherein the one or more output includes an output to render a text based identifier of a computing node in response to the user simultaneously pressing a first bar of the first stack of active bars, a second bar of the second stack of active bars, and a third bar of the third stack of active bars, the computing node specified by the text based identifier having a first condition parameter value of a first condition parameter associated to the first bar, a second condition parameter value of a second condition parameter associated to the second bar, and a third condition parameter value of a third condition parameter associated to the first bar, and wherein the one or more output includes an output to provision a resource of the computer system, wherein the method includes detecting that first and second fingers of the user have pressed the first bar, and wherein the method includes rendering the text based list based on the detecting that the first bar has been pressed by the first and second fingers of the user.

19. The computer program product of claim 17, wherein a width of a certain segment connecting a first bar of the first stack of active bars to a second bar of the second set of active bars is proportional to a quantity of members having a first condition parameter value associated to the first bar and a second condition parameter associated to the second bar.

20. A system comprising:
a memory;
at least one processor in communication with memory; and
program instructions executable by one or more processor via the memory to perform method comprising:
rendering on a display screen a folded multidimensional relationship diagram, wherein the folded multidimensional relationship diagram includes first, second, and third stacks of active bars associated respectively to first, second and third condition parameters, wherein respective bars of first stack of active bars are associated to respective condition parameter values of the first condition parameter, wherein respective bars of second stack of active bars are associated to respective condition parameter values of the second condition parameter, wherein respective bars of third stack of active bars are associated to respective condition parameter values of the third condition parameter, wherein the folded multidimensional relationship diagram includes a first segment set that connects bars of the first stack of active bars to bars of the second stack of active bars, a second segment set that connects bars of the second stack of active bars to bars of the third stack of active bars, and a third segment set that connects bars of the third stack of active bars to bars of the first stack of active bars;
receiving one or more input from a user, the one or more input being in dependence on a user's interaction with the folded multidimensional relationship diagram rendered on the display screen; and
providing one or more output in dependence on the one or more input received from the user.
